(19) United States
(12) Patent Application Publication
(10) Pub. No.: US 2009/0036573 A1
(43) Pub. Date: Feb. 5, 2009

(54) CEMENT-BASED COMPOSITION FOR EXTRUSION MOLDING, PROCESS FOR PRODUCING THE SAME, AND CEMENT PRODUCT

(75) Inventors: Toshihiko Mita, Saitama-shi (JP); Takeyuki Deyama, Tsukuba-shi (JP); Ryuichi Kido, Hannou-shi (JP); Masashi Yamauchi, Kanzaki-gun (JP); Takafumi Akahira, Titubu-gun (JP); Tatsuya Matsui, Tokyo (JP); Sae Kishi, Kawasaki-shi (JP)

Correspondence Address: OLIFF & BERRIDGE, PLC, P.O. BOX 320850, ALEXANDRIA, VA, 22320-4850, US

(73) Assignee: NOF CORPORATION, TOKYO (JP)

(21) Appl. No.: 12/086,979

(22) PCT Filed: Dec. 26, 2006
(86) PCT No.: PCT/JP2006/326333

§ 371 Date: Aug. 28, 2008

(30) Foreign Application Priority Data
Dec. 27, 2005 (JP) 2005-375573

(51) Int. Cl. C04B 24/26

(52) U.S. Cl. 524/5

(57) ABSTRACT

In a cement-based extrusion molding composition, deterioration of productivity due to fluctuation of unburned carbon is prevented by ensuring excellent dispersibility of coal ash mainly composed of fly ash, the extrusion pressure in extrusion molding is reduced, and the strength of a molded product in the same curing condition as in single use of silica sand or silica stone powder is developed. The cement-based extrusion molding composition of the invention comprises: 100 parts by weight of a mixture comprising a hydraulic material, a silicious raw material including fly ash as an essential component and a fiber; 0.1 to 1.5 parts by weight of an extrusion aid; 15 to 45 parts by weight of water; 0.01 to 2.0 parts by weight of a nitrogenous polyoxyalkylene derivative represented by formula (1); and 0.01 to 2.0 parts by weight of a copolymer having a composition of 50 to 99 wt % of a constituting unit (a) represented by formula (2), 1 to 50 wt % of a constituting unit (b) represented by formula (3) and 0 to 30 wt % of a constituting unit (c) derived from another copolymerizable monomer.

### FIELD OF THE INVENTION

The present invention relates to a cement-based extrusion molding composition which contains a specific nitrogenous polyoxyalkylene derivative and a copolymer of a specific polyoxyalkylene derivative, and a cement product obtained by hardening the extrusion molding composition.

### BACKGROUND ARTS

Conventionally, cement-based extrusion molding compositions have been adapted to a higher strength by using silica sand or silica stone powder as a silicious raw material and performing high-temperature, high-pressure curing. From the viewpoint of promotion of effective use of industrial by-products and protection of resources, in recent years, it has been tried to use coal ash or fly ash generated from a coal thermal power plant or the like as the silicious raw material. However, when coal ash mainly composed of fly ash is used as the silicious raw material, the amount of unburned carbon in the fly ash is fluctuated depending on the combustion temperature or kind of coal to cause dispersion of the dispersibility as cement-based extrusion molding composition, in addition to reduced strength, compared with in use of conventional silica sand or silica stone powder. Therefore, problems such as increased screw torque and deterioration of surface smoothness or moldability of a resulting extrusion molded cement product are caused, and the practical use thereof has not been attained yet.

To solve these problems, there is described in Japanese Patent Publication No. H4-46045A and H7-89757A that an extrusion molded product improved in product strength can be provided by setting Blaine value of the material within a regulated range and performing specific curing. Although the product strength can be improved by setting the Blaine value of the material within the regulated range and performing the specific curing, the problem of deterioration of productivity is pointed out since the dispersibility as cement-based extrusion molding composition due to the fluctuation of unburned carbon is not improved.

On the other hand, it is described in Japanese Patent Publication No. 2001-213648A that a dispersant composition effective even for coal ash with large amount of unburned carbon can be provided by using a specific nitrogenous polyoxyalkylene derivative and a polycarboxylic acid-based compound to enhance the dispersibility of coal ash.

### SUMMARY OF THE INVENTION

An object of the prevent invention is to prevent, in a cement-based extrusion molding composition, deterioration of productivity by fluctuation of unburned carbon by ensuring excellent dispersibility of coal ash mainly composed of fly ash, to reduce the extrusion pressure in extrusion molding and to develop the strength of a molded product in the same curing condition as in single use of silica sand or silica stone powder.

That is, the cement-based extrusion molding composition of the present invention comprises:

100 parts by weight of a mixture consisting of a hydraulic material, a silicious raw material including fly ash as an essential component and a fiber;

0.1 to 1.5 parts by weight of an extrusion aid;

15 to 45 parts by weight of water;

0.01 to 2.0 parts by weight of a nitrogenous polyoxyalkylene derivative represented by the following formula (1); and

0.01 to 2.0 parts by weight of a copolymer having a composition of 50 to 99 wt % of a constituting unit (a) represented by the following formula (2), 1 to 50 wt % of a constituting unit (b) represented by the following formula (3) and 0 to 30 wt % of a constituting unit (c) derived from another copolymerizable monomer.

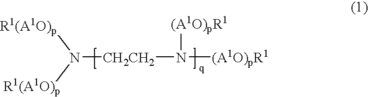

(wherein R¹ represents hydrogen atom, and A¹O represents one or two or more oxyalkylene groups having 2 to 4 carbon atoms, which may be block or random in the case of two or more kinds of oxyalkylene groups, p=0 to 10, and q=1 to 10.)

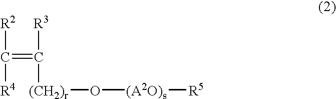

(wherein R², R³ and R⁴ each independently represent hydrogen atom or methyl group, A²O represents one or two or more oxyalkylene groups having 2 to 4 carbon atoms, which may be block or random in the case of two or more kinds of oxyalkylene groups, R⁵ represents hydrogen atom, r=0 to 2, and s=101 to 500.)

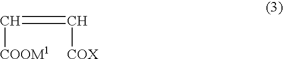

(wherein X represents —OM² or —Y-(A³O)ₜ R⁶, Y represents an ether group or imino group, A³O represents one or two or more oxyalkylene groups each having 2 to 4 carbon atoms, which may be block or random in the case of two or more oxyalkylene groups, R⁶ represents hydrogen atom or a hydrocarbon group having 1 to 22 carbon atoms, M¹ and M² each independently represent hydrogen atom, an alkali metal, an alkaline earth metal, ammonium or an organic ammonium group, and t=1 to 100.)

In a preferred embodiment, A¹O in the nitrogenous polyoxyalkylene derivative represented by the formula (1) is composed of oxyalkylene groups having 2 to 3 carbon atoms with a ratio of oxyalkylene group having 2 carbon atoms to oxyalkylene group having 3 carbon atoms, C2:C3=0 to 80:100 to 20, which may be block or random, p=0 to 8, q=1 to 8, and the clouding point of 1% aqueous solution of the nitrogenous polyoxyalkylene derivative is 50° C. or higher.

In another preferred embodiment, R², R³ and R⁴ in the polyoxyalkylene derivative represented by the formula (2) each represent hydrogen atom, A²O is composed of oxyalkylene groups having 2 to 3 carbon atoms with a ratio of oxyalkylene group having 2 carbon atoms to oxyalkylene group having 3 carbon atoms, C2:C3=40 to 99:60 to 1, which may be block or random, r represents an integer of 1, and s=120 to 500.

In another preferred embodiment, the amount of water to be added to 100 parts by weight of the mixture is 15 to 25 wt % by external ratio.

The present invention also relates to a method for producing the above-mentioned cement-based extrusion molding composition by kneading the above-mentioned hydraulic material, silicious raw material, fiber, water, the nitrogenous polyoxyalkylene derivative represented by the formula (1) and copolymer to thereby prepare a kneaded matter, and adding the above-mentioned extrusion aid to the kneaded matter followed by further kneading.

The present invention further relates to a cement product obtained by hardening the above-mentioned cement-based extrusion molding composition.

According to the cement-based extrusion molding composition of the present invention, the deterioration of productivity due to fluctuation of unburned carbon can be prevented with excellent dispersibility of fly ash, and the load in kneading of extrusion molding material can be reduced to develop the strength of a molded product in the same curing condition as in single use of silica sand or silica stone powder.

In Japanese Patent Publication No. 2001-213648A, no extrusion molding composition differed in properties from concrete is described although the dispersant composition effective even for coal ash with large amount of unburned carbon can be provided by using the specific nitrogenous polyoxyalkylene derivative and the polycarboxylic acid-based compound to enhance the dispersibility of coal ash. The present invention is based on the finding that combined use of this kind of copolymers and an amine-based derivative with the extrusion aid in the cement-based extrusion molding composition enables, in addition to prevention of the deterioration of productivity due to fluctuation of unburned carbon, development of an enormous effect on the strength of a molded product regardless of the curing condition by reduction in the extrusion pressure in extrusion molding.

### BEST MODES FOR CARRYING OUT THE INVENTION

The cement-based extrusion molding composition of the present invention includes a constituting unit based on the nitrogenous polyoxyalkylene derivative represented by the formula (1) as an essential component.

In the formula (1), A¹O represents one or two or more oxyalkylene groups having 2 to 4 carbon atoms, for example, including oxyethylene group, oxypropylene group and oxybutylene group, which may be block or random in the case of two or more oxyalkylene groups, and preferably represents oxyethylene group and oxypropylene group. The ratio of oxyethylene group to oxypropylene group is more preferably oxyethylene group:oxypropylene group=0 to 80:20 to 100, and further preferably 0 to 30:70 to 100.

In the formula (1), p, which shows the addition molar number of oxyalkylene groups having 2 to 4 carbon atoms, is 0 to 10, preferably 0 to 8, more preferably 0 to 5, most preferably 1 or 2. In the formula (1), preferably, all of p is never 0 at the same time, and at least one of p is 1 or more. When the value of p exceeds 10, the resulting compound is undesirably increased in viscosity to make the production difficult.

In the formula (1), q is 1 to 10, preferably 1 to 8, and more preferably 1 to 3.

The clouding point of 1% aqueous solution of the nitrogenous polyoxyalkylene derivative represented by the formula (1) used for the cement-based extrusion molding composition of the present invention is preferably 50° C. or higher. The “clouding point” is defined as “a temperature at which a surfactant aqueous solution starts to cloud when the temperature is raised, and phase separation is generally caused with the clouding” in JIS K 3211 “Surfactant Terms”.

The cement-based extrusion molding composition of the present invention includes the copolymer having a composition consisting of 50 to 99 wt % of the constituting unit (a) based on the polyoxyalkylene derivative represented by the formula (2), 1 to 50 wt % of the constituting unit (b) represented by the formula (3), and 0 to 30 wt % of the constituting unit (c) based on another copolymerizable monomer as an essential component.

In the formula (2), R², R³ and R⁴ each represent hydrogen atom or methyl group, and preferably each represent hydrogen atom. In the formula (2), A²O represents one or two or more oxyalkylene groups having 2 to 4 carbon atoms, for example, including oxyethylene group, oxypropylene group and oxybutylene group, which may be block or random in the case of two or more oxyalkylene groups. It preferably represents oxyethylene group and oxypropylene group, with the ratio of oxyethylene group to oxypropylene group being more preferably oxyethylene group:oxypropylene group=40 to 99:60 to 1, further preferably oxyethylene group oxypropylene group=90 to 99:10 to 1.

In the formula (2), s, which shows the addition molar number of oxyalkylene groups having 2 to 4 carbon atoms, is 101 to 500, preferably 120 to 500, and more preferably 130 to 400. When the value of s exceeds 500, the resulting compound is undesirably increased in viscosity to make the production difficult.

In the formula (2), r, which shows the repeat number of methylene groups, is an integer of 0 to 2, and preferably 1.

In the formula (3), M¹ and M² each represent hydrogen atom, an alkali metal, an alkaline earth metal, an ammonium or an organic ammonium. Examples of the alkali metal include lithium, sodium, potassium and rubidium.

Examples of the alkaline earth metal include magnesium and calcium.

The organic ammonium is an ammonium derived from organic amine, and examples of the organic amine include alkanolamine such as monoethanolamine, diethanolamine or triethanolamine, and alkylamine such as methylamine, dimethylamine, trimethylamine, ethylamine, diethylamine or triethylamine. Among them, monoethanolamine, diethanolamine, methylamine, ethylamine, dimethylamine and diethylamine are preferred.

In the formula (3), X is —OM² or —Y-(A³O)ₜ R⁶. Y represents an ether group or imino group, the ether group being —O—, and the imino group being —NH—. t, which shows the addition molar number of oxyalkylene groups having 2 to 4 carbon atoms, is 1 to 100, preferably 10 to 100, and more preferably 20 to 70. When the value of t exceeds 100, the resulting compound is undesirably increased in viscosity to make the production difficult.

The constituting unit based on another polymerizable monomer, which constitutes the copolymer with polyoxyalkylene derivative used for the cement-based extrusion molding composition of the present invention, may be added without deteriorating the effect of the present invention, and examples thereof include vinyl acetate, sodium allylsulfonate, sodium methallylsulfonate, methacrylic acid, and acrylic acid.

The copolymer with polyoxyalkylene derivative used for the cement-based extrusion molding composition of the present invention is composed of 50 to 99 wt % of the constituting unit (a) based on the polyoxyalkylene derivative represented by the formula (2), 1 to 50 wt % of the constituting unit (b) represented by the formula (3), and 0 to 30 wt % of the constituting unit based on another copolymerizable monomer. Preferable amounts of (a), (b) and (c) are 80 to 99 wt %, 1 to 20 wt %, and 0 to 20 wt %, respectively.

The copolymer with polyoxyalkylene derivative used for the cement-based extrusion molding composition of the present invention has a weight average molecular weight of 500 to 100,000, preferably of 5,000 to 50,000. A compound with a weight average molecular weight exceeding 100,000 is undesirable since reduction in the dispersibility as cement-based extrusion molding composition is caused, and an increased viscosity makes the production difficult.

The copolymer with polyoxyalkylene derivative used for the cement-based extrusion molding composition of the present invention can be obtained by performing polymerization by use of a polymerization initiator according to a known method. The polymerization method may be bulk polymerization or solution polymerization. In solution polymerization using water as solvent, a persulfate such as sodium persulfate, potassium persulfate or ammonium persulfate, hydrogen peroxide, or a water-soluble azo-based initiator can be used, and a promoter such as sodium hydrogen sulfite, hydroxylamine hydrochloride, thiourea, or sodium hypophosphite can be used also in combination therewith. In solution polymerization using a lower alcohol such as methanol, ethanol or isopropanol, an aliphatic hydrocarbon such as n-hexane, 2-ethylhexane or cyclohexane, an aromatic hydrocarbon such as toluene or xylene, or an organic solvent such as acetone, methyl ethyl ketone or ethyl acetate, or in bulk polymerization, an organic peroxide such as benzoyl peroxide, di-t-butyl peroxide or t-butyl peroxiisobutylate or an azo-based compound such as azoisobutyronitrile can be used. In such case, a chain transfer agent such as thioglycolic acid or mercaptoethanol can be used together.

In the polymerization reaction, the constituting unit (a) based on the polyoxyalkylene derivative represented by the formula (2), the constituting unit (b) represented by the formula (3), the constituting unit (c) based on another copolymerizable monomer, and the polymerization initiator are charged to perform the reaction. These components may be charged at a time, or a part of each component may be added by dripping. The constituting unit (b) represented by the formula (3) can be charged in the form of anhydride at the time of charging, and ring-opened with water, an alkali metal hydroxide, an alkali earth metal hydroxide, an ammonium or an organic amine after, during or before the polymerization.

The composition of the present invention further includes the hydraulic material as an essential component. The hydraulic material means a material which is hardened by hydration reaction after kneaded with water. Examples of the hydraulic material include Portland cement such as ordinary, early-strength, moderate heat or belite cement, alumina cement, plaster and the like. These may be used alone or in combination of two or more thereof. The amount of the hydraulic material preferably accounts for, for example, 25 to 75 parts by weight to 100 parts by weight of the mixture, although it is not particularly limited.

The composition of the present invention further includes the silicious raw material as an essential component. The silicious raw material means a raw material mainly composed of silicic acid. Although the composition of the present invention includes at least fly ash as the silicious raw material, it may include a silicious raw material other than fly ash. Examples of such silicious raw material include silica stone powder, blast-furnace slag, silica fume, volcanic ash, and pozolan. These raw materials other than fly ash described can be used as the silicious raw material singly or in combination of two or more thereof. The particularly preferable silicious raw material other than fly ash is silica stone powder.

The total amount of the silicious raw materials preferably accounts for 20 to 70 parts by weight to 100 parts by weight of the mixture although it is not particularly limited. The amount of fly ash is preferably 10 to 50 parts by weight to 100 parts by weight of the mixture.

As the above-mentioned hydraulic material, a hydraulic material free from the silicious raw material can be mixed. In this case, the silicious raw material and the hydraulic material are acquired separately and then mixed together. Otherwise, a mixed raw material in which the hydraulic material is preliminarily mixed with a silicious material can be used. In this case, the final mixing ratio of the hydraulic material:silicious raw material can be adjusted by mixing the silicious material and/or the hydraulic material separately to the mixed raw material. Otherwise, when a predetermined amount of the silicious raw material is preliminarily mixed to the mixed raw material, separate addition of the silicious raw material or hydraulic material may be unnecessary.

Examples of the mixed raw material include mixed cement containing cement (e.g., Portland cement) and fly ash, blast-furnace slag, silica fume or the like.

The composition of the present invention may include an aggregate. Examples of the aggregate include river sand, silica sand, ballast, limestone, lightweight aggregate, and wallastonite. Such aggregates may be used singly or in combination of two or more thereof. The amount of the aggregate preferably accounts for, for example, 0 to 30 parts by weight to 100 parts by weight of the mixture although it is not particularly limited.

The composition of the present invention includes the fiber as an essential component. Examples of the fiber include an inorganic fiber such as glass fiber or carbon fiber and an organic fiber such as pulp, used paper, polyamide fiber, polyester fiber, polypropylene fiber or vinylon fiber. Such fibers may be used singly or in combination of two or more thereof. Among them, pulp is preferred. The amount of the fiber preferably accounts for, for example, 1 to 10 parts by weight to 100 parts of the mixture although it is not particularly limited.

The cement-based extrusion molding composition of the present invention includes the extrusion aid as an essential component. Examples of the extrusion aid include a cellulose derivative such as methyl cellulose, ethyl cellulose, hydroxypropyl cellulose, hydroxyethyl cellulose, hydroxyethyl methyl cellulose or hydroxypropyl methyl cellulose, and a water-soluble polymer compound such as a polyether urethane resin, a polyvinyl alcohol, a polyethylene oxide or polyacrylamide. Among them, the cellulose derivative and polyether urethane resin are preferably used, and methyl cellulose, hydroxypropyl cellulose, hydroxyethyl methyl cellulose and hydroxypropyl methyl cellulose are particularly preferred.

The extrusion aid is added preferably in an amount of 0.1 to 1.5 parts by weight, by external ratio, to 100 parts by weight of the mixture composed of the hydraulic material, the silicious raw material and the fiber, more preferably in an amount of 0.2 to 1.0 parts by weight. Although it depends on the mixing condition of the mixture composed of the hydraulic material, the silicious raw material and the fiber, when the amount of the extrusion aid is below this range, the performance of the extrusion aid cannot be exhibited so that pull crack can be easily caused in the product after extrusion molding. When the amount is beyond this range, swelling is undesirably caused in the extrusion molded product by springback phenomenon.

The amount of the nitrogenous polyoxyalkylene derivative to 100 parts by weight of the mixture is 0.01 to 2.0 parts by weight by external ratio, preferably 0.03 to 1.0 parts by weight, and more preferably 0.05 to 0.8 parts by weight. When the amount of the polyoxyalkylene derivative is below this range, the effect of the present invention is hardly obtained. When the amount is beyond this range, the viscosity of the extrusion aid such as methylcellulose is lost, and pull crack may be easily caused in the extrusion molded product.

The amount of the copolymer with polyoxyalkylene derivative to 100 parts by weight of the mixture is 0.01 to 2.0 parts by weight by external ratio, preferably 0.03 to 1.0 parts by weight, and more preferably 0.05 to 0.5 parts by weight. When the amount of the copolymer with polyoxyalkylene derivative is below this range, the effect of the present invention is hardly obtained. When the amount is beyond this range, the viscosity of the extrusion aid such as methylcellulose is lost, and pull crack may be easily caused in the extrusion molded product.

The amount of water to 100 parts by weight of the mixture is 15 to 45 parts by weight by external ratio. The amount of water is 30 parts by weight or less, preferably 25 parts by weight or less. When the amount of water is less than 15 parts by weight, the load in kneading of the extrusion molding composition is undesirably increased.

When the mixture is prepared, other raw materials except the extrusion aid are kneaded first to sufficiently adsorb the additive of the present invention to unburned carbon in fly ash, and the extrusion aid is thereafter added followed by further kneading, whereby adsorption of the extrusion aid to the unburned carbon can be eliminated. Consequently, the dispersing performance of the extrusion aid can be sufficiently exhibited, so that molding can be performed with a smaller amount of water. Therefore, the resulting molded body can ensure further excellent performances.

When an extrusion molded product is produced according to the present invention, the above-mentioned components and other optional components as needed are added and mixed together by an ordinary method to prepare an extrusion molding composition, and the extrusion molding composition is charged in an extrusion molding machine mounted with a desired base, and extrusion-molded with the inside of the extrusion molding machine being in a vacuum state. After completion of such extrusion molding, the resulting molded body is precured by being allowed to stand at room temperature for 2 to 3 hours, and then wet cured (primarily cured) by retaining it at 60° C. for about 6 to 10 hrs. Successively, autoclave curing of (0.1 to 2 MPa)×(4 to 8 hrs) is performed followed by natural cooling, whereby the molded product is completed.

### EXAMPLES

The present invention will be further described in reference to examples. The structural formula of the compound represented by the formula (1) is shown in Table 1, and the structural formula of the compound represented by the formula (2), the structural formula of the compound represented by the formula (3), and copolymerized composition and weight average molecular weight thereof are shown in Table 2.

TABLE 1

| Production | |
|---|---|
| Example | Compound represented by formula (1) |
| 1 | 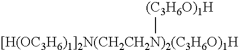 |
| 2 | 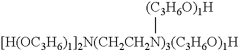 |

TABLE 2

| | | | Weight |
|---|---|---|---|
| | | Compound | Average |
| | | represented | Molecular |
| | Compound represented by | by | Weight |
| Production | Formula (1) | Formula (2) | (by |
| Example | (weight %) | (weight %) | GPC) |
| 5 | H₂C═CHCH₂O[(C₃H₆O)₁₁/ | Disodium | 40,600 |
| | (C₂H₄O)₂₁₀]H | Maleate | |
| | 90.3 | 9.7 | |

### Production Example 1

Diethylenetriamine 520 g (5.0 moles) was measured into a 5-1 pressure reactor, and addition reaction was performed by gradually injecting, after substituting the air within the system by nitrogen gas, propylene oxide 1,450 g (25.0 moles) thereto at 100±5° C. with about 0.05 to 0.5 MPa (gauge pressure). After completion of the reaction, the reaction mixture was cooled to 60° C. A 1% aqueous solution was prepared using a part of the resulting nitrogenous polyoxyalkylene derivative to measure the clouding point thereof. As a result, the clouding point was higher than 50° C. (100° C. or higher).

### Production Example 2

The same reaction as in Production Example 1 was performed using triethylene tetramine to thereby obtain a nitrogenous polyoxyalkylene derivative. A 1% aqueous solution was prepared using a part of the nitrogenous polyoxyalkylene derivative to measure the clouding point. As a result, the clouding point was higher than 50° C. (100° C. or higher).

### Production Example 3

Ethylenediamine 48 g (0.8 mole) and caustic potassium 0.48 g were measured into a 5-1 pressure reactor, and addition reaction was performed by gradually injecting, after substituting the air within the system by nitrogen gas, propyleneoxide 2,227 g (38.4 moles) thereto at 100±5° C. with about 0.05 to 0.5 MPa (gauge pressure). After completion of the reaction, ethyleneoxide 282 g (6.4 moles) was gradually injected thereto at 120±5° C. with about 0.05 to 0.5 MPa (gauge pressure) to perform addition reaction. A 1% aqueous solution was prepared using a part of the resulting nitrogenous polyoxyalkylene derivative to measure the clouding point. As a result, the clouding point was 25° C.

### Production Example 4

Octadecylamine 269 g (1.0 mole) and caustic soda 1.15 g were measured into a 5-1 pressure reactor, and addition reaction was performed by gradually injecting, after substituting the air within the system by nitrogen gas, ethyleneoxide 880 g (20 moles) thereto at 120±5° C. with about 0.05 to 0.5 MPa (gauge pressure). A 1% aqueous solution was prepared using a part of the resulting nitrogenous polyoxyalkylene derivative to measure the clouding point. As a result, the clouding point was higher than 50° C. (100° C. or higher).

### Production Example 5

Polyoxyethylene (average addition molar number of ethyleneoxide 210) oxypropylene (average addition molar number of propylene oxide 11) monoallyl ether 994 g (0.1 mole), water 707 g, and maleic anhydride 58.8 g (0.6 mole) were charged into a 3-1 flask installed with an agitator, a thermometer, a nitrogen gas inlet tube and a reflux cooler, sodium persulfate 24.2 g (0.1 mole) was added thereto as a polymerization initiator at 35° C., and the mixture was reacted at 60±2° C. for 10 hours after substituting the air within the system by nitrogen gas. Ater completion of the polymerization reaction, 48%-aqueous solution of sodium hydroxide 100 g (1.2 moles as sodium hydroxide) was added thereto to neutralize the reaction solution, and water 929 g was further added to thereby obtain a 40%-aqueous solution of a copolymer.

### Examples 1 to 6

### Comparative Examples 1 to 8

The raw material composition used is shown in Composition 1 of Table 3. Concretely, to 100 parts by weight of a mixture consisting of general Portland cement (produced by Mitsubishi Materials) as the hydraulic material, fly ash (produced by Nakoso Power Plant of Joban Joint Power, JIS Type II) as the silicious raw material, river sand (fineness modulus 1.2, produced in Kashima, Ibaraki) as the aggregate, and residual newspaper pulverized pulp (15-mesh passing, produced by Oji Paper) as the fiber, hydroxyethyl methyl cellulose (SNB-60T, produced by Shin-Etsu Chemical) as the extrusion aid, the nitrogenous polyoxyalkylene derivative shown in each of Production Examples 1 to 4, the copolymer shown in Production Example 5, and water were added in an external ratio shown in Table 4. The materials except the nitrogenous polyoxyalkylene derivative, the copolymer and water were homogenously mixed for 2 minutes by an Eirich mixer, and thereafter the nitrogenous polyoxyalkylene derivative, and the copolymer and water were externally added thereto. The material which was mixed for 2 minutes after starting rise of current value by loading on the agitator current of the mixer was extrusion-molded by an extrusion molding machine installed with a die of thickness 60 mm and width 600 mm, subjected to wet curing in a condition of 60° C.×8 hrs and then to autoclave curing in a condition of 1 MPa×6 hrs, and cut in a length of 3,000 mm to thereby obtain a product.

TABLE 3

| | Composition 1 | | Composition 2 | |
|---|---|---|---|---|
| Cement | 51 | parts | 51 | parts |
| Silicious raw material | 30 | | 30 | |
| River sand | 15 | | — | |
| Lightweight aggregate | — | | 15 | |
| Pulp | 4 | | 4 | |

For such a product, extrusion load current, kneading time after addition of water, appearance after molding, linearity of product, bending strength and bulk specific gravity were measured. The results are shown in Table 4.

TABLE 4

| | Composition 1 | | | | | |
|---|---|---|---|---|---|---|
| | Inventive examples | | | | | |
| | Unburned carbon amount = 2.0% | | | Unburned carbon amount = 3.0% | | |
| | 1 | 2 | 3 | 4 | 5 | 6 |
| Additives | Production 1 | Production 2 | Production 1 | Production 1 | Production 2 | Production 1 |
| Derivative of | 0.2 | 0.2 | 0.2 | 0.2 | 0.2 | 0.2 |
| Formula (1) | | | | | | |
| Amount of Additive*¹ | | | | | | |
| (weight %) | | | | | | |
| Extrusion Aid*² | 0.5 | 0.5 | 0.5 | 0.5 | 0.5 | 0.5 |
| (weight %) | | | Post addition | | | Post addition |
| Amount of Additive | 0.2 | 0.2 | 0.2 | 0.2 | 0.2 | 0.2 |
| in Production 5*³ | | | | | | |
| (weight %) | | | | | | |
| Water (weight %) | 20 | 20 | 19 | 20 | 20 | 19 |
| Extrusion load | 260~270 | 260~270 | 265~275 | 270~280 | 270~280 | 275~285 |
| Current (A) | | | | | | |
| Kneading time | 4 | 4 | 4 | 4 | 4 | 4 |
| After water | | | | | | |
| addition (minute) | | | | | | |
| Appearance after | ⊚ | ⊚ | ⊚ | ⊚ | ⊚ | ⊚ |
| molding | | | | | | |
| Linearlity | ⊚ | ⊚ | ⊚ | ⊚ | ⊚ | ⊚ |
| Bending strength*⁴ | 18.3 | 18.2 | 18.9 | 17.7 | 18.1 | 18.5 |
| (N/mm²) | | | | | | |
| Bulk density | 1.84 | 1.84 | 1.85 | 1.84 | 1.84 | 1.85 |

| | Composition 1 | | | | | | | |
|---|---|---|---|---|---|---|---|---|
| | Comparative examples | | | | | | | |
| | Unburned carbon amount = 2.0% | | | | Unburned carbon amount = 3.0% | | | |
| | 1 | 2 | 3 | 4 | 5 | 6 | 7 | 8 |
| Additives | None | None | Production 3 | Production 4 | None | None | Production 3 | Production 4 |
| Derivative of | — | — | 0.2 | 0.2 | — | — | 0.2 | 0.2 |
| Formula (1) | | | | | | | | |
| Amount of Additive*¹ | | | | | | | | |
| (weight %) | | | | | | | | |
| Extrusion Aid*² | 1.0 | 0.8 | 0.5 | 0.5 | 1.0 | 0.8 | 0.5 | 0.5 |
| (weight %) | | | | | | | | |
| Amount of Additive | | 0.2 | 0.2 | 0.2 | | 0.2 | 0.2 | 0.2 |
| in Production 5*³ | | | | | | | | |
| (weight %) | | | | | | | | |
| Water | 22 | 21 | 21 | 21 | 24 | 22 | 22 | 22 |
| (weight %) | | | | | | | | |
| Extrusion load | 255~265 | 260~270 | 260~270 | 260~270 | 250~260 | 260~270 | 270~280 | 265~275 |
| Current (A) | | | | | | | | |
| Kneading time | 4 | 4 | 4 | 4 | 4 | 4 | 4 | 4 |
| After water | | | | | | | | |
| addition (minute) | | | | | | | | |
| Appearance | ◯ | ◯ | ◯ | ◯ | Δ | ◯ | ◯ | ◯ |
| after molding | | | | | | | | |
| Linearlity | ◯ | ◯ | ◯ | ◯ | Δ | Δ | ◯ | ◯ |
| Bending strength*⁴ | 17.1 | 17.5 | 17.3 | 17.4 | 16.5 | 16.7 | 16.9 | 17.0 |
| (N/mm²) | | | | | | | | |
| Bulk density | 1.77 | 1.82 | 1.82 | 1.82 | 1.68 | 1.77 | 1.77 | 1.78 |

*¹The addition amount of the nitrogenous polyoxyalkylene derivative represented by the formula (1) is based on solid content.
*²As the extrusion aid, hydroxyethyl methyl cellulose (SNB-60T, produced by Shin-Etsu Chemical) was used.
*³The addition amount of the copolymer of Production Example 4 is based on solid content.
*⁴For the bending strength, the autoclave-cured product was cut in a length of 1,300 mm after cooled
to ordinary temperature, and subjected to bending test with quarter 2-line load. The bending strength was
calculated according to the following equation.
Fb: Panel bending strength (N/mm²)
P: Bending fracture load (N)
L: Support span length (1,200 mm)
Z: Section modulus (307 mm³)
W: Dead load of specimen (N)
${F}_{b} = \frac{PL}{8 Z} + \frac{wL}{8 Z}$
(Evaluation Reference for “Appearance after molding”)
⊚: Δt < 0.5 mm
◯: 0.5 mm < Δt < 1 mm
Δ: 1 mm < Δt < 2 mm
x: Δt > 2 mm
wherein Δt = thickness error.
(Evaluation Reference for “Linearity”)
⊚: ΔL < 1 mm
◯: 1 mm < ΔL < 2 mm
Δ: 2 mm < ΔL < 3 mm
x: ΔL > 3 mm
wherein ΔL = Linerality error.

In comparison between Examples 1, 2 and 3 and Examples 4, 5 and 6, even if the unburned carbon amount is increased, a constant extrusion load current can be ensured without needing an increase in amount of water, and satisfactory appearance after molding, good linearity and high bending strength are obtained.

In comparison between Comparative Examples 1, 2 and 5, 6, on the other hand, when the amount of unburned carbon is 3.0%, 3%- or 1%-increase in amount of water is needed, and the appearance after molding and the linearity are deteriorated, with the bending strength being also inferior to those in Examples. In an actual production field, the amount of unburned carbon is varied since the material supply cannot be always performed while strictly measuring and controlling the amount of unburned carbon. Therefore, the necessity of change in amount of water by 1% or more for extrusion means that the composition concerned is hardly practically used in the production field.

In comparison between Comparative Examples 3, 4 and 7, 8, when the unburned carbon quantity is 3.0%, 1%-increase in amount of water is needed, and the appearance after molding and the linearity are deteriorated, with the bending strength being also inferior to those in Examples.

### Examples 7 to 10

### Comparative Examples 9 to 14

The raw material composition used is shown in Composition 2 of Table 3. Concretely, the same materials as in Example 1 were used for the hydraulic material and the pulp, and fly ash (produced by Nakoso Power Plant of Joban Joint Power, JIS Type II) as the silicious raw material, lightweight aggregate (perlite) (average particle size 0.6 mm or less, produced by Ube Perlite) as the aggregate were used. Hydroxyethyl methyl cellulose (SNB-60T, produced by Shin-Etsu Chemical) as the extrusion aid, the nitrogenous polyoxyalkylene derivative shown in each of Production Examples 1 to 3, the copolymer shown in Production Example 5, and water were externally added in a ratio shown in Table 5. The materials except the nitrogenous polyoxyalkylene derivative, the copolymer and water were homogenously mixed for 2 minutes by an Eirich mixer, and the nitrogenous polyoxyalkylene derivative, the copolymer and water were externally added thereto. The material which was mixed for 2 minutes after starting rise of current value by loading on the agitator current of the mixer was extrusion-molded by an extrusion molding machine installed with a die of thickness 60 mm and width 600 mm, subjected to wet curing in a condition of 60° C.×8 hrs and then to autoclave curing in a condition of 1 MPa×6 hrs, and cut in a length 3,000 mm to thereby obtain a product.

For such a product, extrusion load current, kneading time after addition of water, appearance after molding, linearity of product, bending strength and bulk specific gravity were measured. The results are shown in Table 5.

TABLE 5

| Composition 2 | |
|---|---|
| Inventive examples | |
| Amount of unburned | Amount of unburned |
| carbon = 2.0% | carbon = 3.0% |

| | 7 | 8 | 9 | 10 |
|---|---|---|---|---|
| Additives | Production 1 | Production 2 | Production 1 | Production 2 |
| Additive of invention | 0.2 | 0.2 | 0.2 | 0.2 |
| Addition amount*¹ | | | | |
| (weight %) | | | | |
| Extrusion aid*² | 0.5 | 0.5 | 0.5 | 0.5 |
| (weight %) | | | | |
| Production*³ | 0.2 | 0.2 | 0.2 | 0.2 |
| (weight %) | | | | |
| Water (weight %) | 37 | 37 | 37 | 37 |
| Extrusion load current | 170~200 | 170~200 | 170~200 | 170~200 |
| (A) | | | | |
| Blending time After | 4 | 4 | 4 | 4 |
| water addition | | | | |
| (minute) | | | | |
| Appearance after | ⊚ | ⊚ | ⊚ | ⊚ |
| Molding | | | | |
| Linearity | ◯ | ◯ | ◯ | ◯ |
| Bending Strength*⁴ | 11.8 | 12.2 | 11.5 | 11.7 |
| (N/mm²) | | | | |
| Bulk density | 1.15 | 1.16 | 1.15 | 1.15 |

| | Composition 2 | | | | | |
|---|---|---|---|---|---|---|
| | Comparative examples | | | | | |
| | Amount of unburned carbon = | | | Amount of unburned carbon = | | |
| | 2.0% | | | 3.0% | | |
| | 9 | 10 | 11 | 12 | 13 | 14 |
| Additives | None | None | Production 3 | None | None | Production 3 |
| Additive of | — | — | 0.2 | — | — | |
| invention | | | | | | |
| Addition amount*¹ | | | | | | |
| (weight %) | | | | | | |
| Extrusion aid*² | 1.0 | 0.8 | 0.5 | 1.0 | 0.8 | 0.5 |
| (weight %) | | | | | | |
| Production*³ | | 0.2 | 0.2 | | 0.2 | 0.2 |
| (weight %) | | | | | | |
| Water (weight %) | 39 | 38 | 38 | 41 | 39 | 40 |
| Extrusion load | 170~200 | 180~200 | 170~200 | 160~190 | 190~200 | 180~190 |
| current (A) | | | | | | |
| Blending time | 4 | 4 | 4 | 4 | 4 | 4 |
| After water | | | | | | |
| addition (minute) | | | | | | |
| Appearance after | ◯ | ⊚ | ◯ | ◯ | ◯ | Δ |
| Molding | | | | | | |
| Linearity | ◯ | ◯ | ◯ | ◯ | ◯ | Δ |
| Bending Strength*⁴ | 10.6 | 11.3 | 12.2 | 10.1 | 10.7 | 10.4 |
| (N/mm²) | | | | | | |
| Bulk density | 1.11 | 1.13 | 1.13 | 1.07 | 1.10 | 1.09 |

In Examples 7, 8, 9 and 10, even if the amount of unburned carbon is changed, increase in amount of water is not needed, and satisfactory appearance after molding, good linearity and high bending strength are obtained.

In Comparative Examples 9 to 14, when the amount of unburned carbon is 3.0%, particularly, 1%- to 2%-increase in amount of water is needed, and the appearance after molding and the linearity are deteriorated, with the bending strength being also inferior to those in Examples.

As described above, according to the present invention, even if fly ash is used as the raw material, the influence on moldability and physical properties by the amount of unburned carbon contained therein and the dispersion thereof can be eliminated, and a product excellent in appearance and physical properties can be obtained.

While specific embodiments have been shown and described, the present invention is never limited by these specific embodiments and can be carried out with various modifications and substitutions without departing from the scope of the claims.

1. A cement-based extrusion molding composition comprising:
100 parts by weight of a mixture consisting of a hydraulic material, a silicious raw material including fly ash as an essential component and a fiber;
0.1 to 1.5 parts by weight of an extrusion aid;
15 to 45 parts by weight of water;
0.01 to 2.0 parts by weight of a nitrogenous polyoxyalkylene derivative represented by the following formula (1); and
0.01 to 2.0 parts by weight of a copolymer having a composition of 50 to 99 wt % of a constituting unit (a) represented by the following formula (2), 1 to 50 wt % of a constituting unit (b) represented by the following formula (3), and optionally 0 to 30 wt % of a constituting unit (c) derived from another copolymerizable monomer. 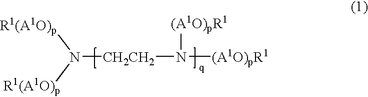
(wherein R¹ represents hydrogen atom, A¹O represents one or two or more oxyalkylene groups having 2 to 4 carbon atoms, which may be block or random in the case of two or more oxyalkylene groups, p=0 to 10 and q=1 to 10.) 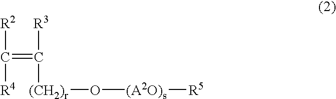
(wherein R², R³ and R⁴ each independently represent hydrogen atom or methyl group, A²O represents one or two or more oxyalkylene groups having 2 to 4 carbon atoms, which may be block or random in the case of two or more oxyalkylene groups, R⁵ represents hydrogen atom, r represents an integer of 0 to 2, and s=101 to 500.) 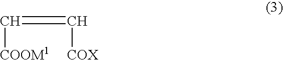
(wherein X represents —OM² or —Y-(A ³O)ₜ R⁶, Y represents an ether group or imino group, A³O represents one or two or more oxyalkylene groups having 2 to 4 carbon atoms, which may be block or random in the case of two or more oxyalkylene groups, R⁶ represents hydrogen atom or a hydrocarbon group having 1 to 22 carbon atoms, M¹ and M² each independently represent hydrogen atom, an alkali metal, an alkaline earth metal, an ammonium or an organic ammonium group, and t=1 to 100.)

2. The cement-based extrusion molding composition of claim 1, wherein, in said nitrogenous polyoxyalkylene derivative represented by the formula (1), A¹O is composed of oxyalkylene groups having 2 to 3 carbon atoms with a ratio of oxyalkylene group having 2 carbon atoms to oxyalkylene group having 3 carbon atoms (C2:C3) is 0 to 80:100 to 20, which may be block or random, p=0 to 8 and q=1 to 8, and wherein the clouding point of 1% aqueous solution of said nitrogenous polyoxyalkylene derivative is 50° C. or higher.

3. The cement-based extrusion molding composition of claim 1, wherein, in said polyoxyalkylene derivative represented by the formula (2), R²R³ and R⁴ each represent hydrogen atom, A²O is composed of oxyalkylene groups having 2 to 3 carbon atoms with a ratio of oxyalkylene group having 2 carbon atoms to oxyalkylene group having 3 carbon atoms (C2:C3) is 40 to 99:60 to 1, which may be block or random, r=1 and s=120 to 500.

4. The cement-based extrusion molding composition of claim 1, wherein the amount of water added to 100 parts by weight of said mixture is 15 to 25 wt %.

5. A method for producing said cement-based extrusion molding composition of claim 1, the method comprising the steps of:
kneading said hydraulic material, said silicious raw material, said fiber, water, said nitrogenous polyoxyalkylene derivative represented by the formula (1) and said copolymer to prepare a kneaded matter; and
adding said extrusion aid to said kneaded matter followed by further kneading.

6. A cement product produced by hardening said cement-based extrusion molding composition of claim 1.
